(19) United States
(12) Patent Application Publication
(10) Pub. No.: US 2011/0234880 A1
(43) Pub. Date: Sep. 29, 2011

(54) Camera configured to issue a warning

(75) Inventor: Toshiharu Matsuda, Souka-shi (JP)

(73) Assignee: NIKON CORPORATION, TOKYO (JP)

(21) Appl. No.: 13/067,505

(22) Filed: Jun. 6, 2011

Related U.S. Application Data
(63) Continuation of application No. 11/979,204, filed on Oct. 31, 2007, now abandoned.

(30) Foreign Application Priority Data
Nov. 7, 2006 (JP) 2006-301686

(51) Int. Cl. H04N 5/225

(52) U.S. Cl. 348/333.04; 348/E05.024

(57) ABSTRACT

This camera includes a display device that displays a photographic condition, and a detection unit that detects a problem related to photography of which a photographer should be warned. When some problem is detected by the detection means, notification thereof is provided via a specification display (a simple warning message) for notifying of the detected problem, for example by blinking an in-viewfinder help mark; and when a specified actuation (for example the depression of a help button) is performed while this specification display is being provided, a warning message (a detailed warning message) that describes in text the details of the problem that has been detected is displayed upon the display device (for example, a liquid crystal monitor).

This is a Continuation of application Ser. No. 11/979,204 filed Oct. 31, 2007. The disclosure of the prior application is hereby incorporated by reference herein in its entirety.

### INCORPORATION BY REFERENCE

The contents of the disclosure of the following patent application, upon which priority is claimed, is hereby incorporated by reference:

Japanese Patent Application No. 2006-301686 (filed on Nov. 7, 2006).

### BACKGROUND OF THE INVENTION

1. Field of the Invention

The present invention relates to a camera, and more particularly relates to a method of issuing a warning when a problem has arisen in connection with photography.

2. Description of Related Art

A camera is per se known that is provided with an element within its viewfinder for displaying the occurrence of trouble, and with which, when some problem arises, illuminates this element so as to notify the photographer, and simultaneously displays a pattern or symbolic mark (hereinafter generically termed a “pattern”) that specifies the details of the problem upon another display unit (for example, refer to Japanese Laid-open Patent Application No. S61-0279835).

With this camera, the details of the problem are displayed only as a pattern, and sometimes it is not possible for the user immediately to ascertain the meaning of this pattern. Furthermore although, with this camera, when some problem occurs the details of the problem are always displayed, sometimes, when it is not actually necessary to display these details, this display may constitute an impediment to some other display.

### SUMMARY OF THE INVENTION

The camera according to the present invention includes a display device that displays a photographic condition, and a detection unit that detects a problem related to photography of which a photographer should be warned; and, when some problem is detected by the detection means, a specification display for notifying of the problem is provided upon the display device; and, when a specified actuation is performed by the photographer while this specification display is being provided, a warning message that describes in text the details of the problem is displayed upon the display device.

The warning message may be displayed so as to cover over and hide the display of the photographic condition.

The specification display for notifying the occurrence of the problem may be provided in a viewfinder.

The warning message may include a method of dealing with the problem that has occurred.

If one problem for which a warning should be issued is a problem that exerts an influence upon photographic operation and another is a problem that influences the result of photography, to arrange for a simple warning message to be displayed upon the display device simultaneously with the specification display, when the problem that exerts an influence upon photographic operation has been detected, and a detailed warning message may be displayed upon the display device, when the specified actuation is performed by the photographer.

The camera may include an in-viewfinder display device including an information display unit that displays information within a viewfinder of the camera, and that displays the specification display as information upon the information display unit, and an in-viewfinder display device control unit that controls the display of information upon the in-viewfinder display device.

The warning message may include at least one warning selected from a card full warning, a card not inserted warning, an outside photometric range warning related to a first luminance limit, an outside photometric range warning related to a second luminance limit, a flash usage recommended warning, and a flash bounce warning.

The display device that displays the photographic condition may be provided upon a rear surface of the camera.

The camera is desirably a single lens reflex type digital camera to which a detachable photographic lens is attached.

According to the present invention, it is possible immediately to ascertain the details of a problem that has occurred, and moreover it is possible to ensure that unnecessary warnings are not displayed.

### BRIEF DESCRIPTION OF THE DRAWINGS

FIG. 1 is a rear view of a digital camera according to an embodiment of the present invention;

FIG. 2 is a block diagram showing a control system of the camera shown in FIG. 1;

FIG. 3 is a figure showing an example of display of photographic conditions and a simple warning message upon a liquid crystal monitor;

FIG. 4 is a figure showing an example of display of a warning message (a detailed message) upon this liquid crystal monitor;

FIG. 5 is a figure showing an in-viewfinder display unit;

FIG. 6 is a figure showing a situation in which a help mark is caused to blink upon this in-viewfinder display unit;

FIG. 7 is a figure showing a correspondence between an assortment of warnings and the corresponding warning messages;

FIG. 8 is a figure showing an example of display of another warning message (a detailed message) upon the liquid crystal monitor;

FIG. 9 is a flowchart showing an example of a control sequence (steps) for implementing this warning display; and

FIG. 10 is a flowchart continuing on from FIG. 9.

### DETAILED DESCRIPTION OF THE PREFERRED EMBODIMENT

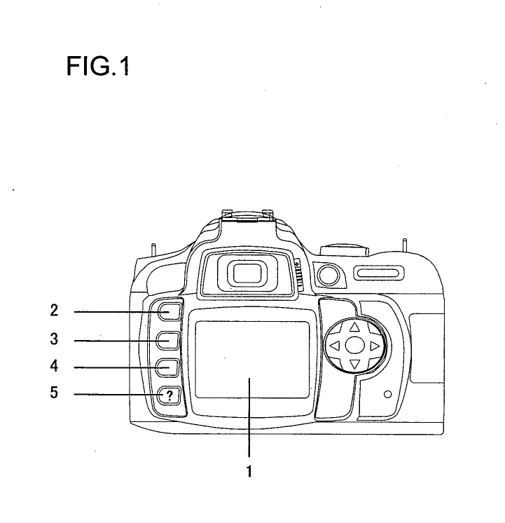

An embodiment of the present invention will now be explained with reference to FIG. 1 through FIG. 10.

FIG. 1 is a rear view showing a single lens reflex type digital camera according to an embodiment of the present invention. A large sized color liquid crystal monitor 1 is provided upon the rear surface of this camera, and images and various types of information can be displayed on this monitor 1. Setting buttons 2 to 4 and a help button 5 are provided beside this liquid crystal monitor 1. The help button 5 is used when displaying a help display or a warning message.

Now, with a prior art camera, apart from the liquid crystal monitor 1 on the rear camera surface, it has been conventional to provide an auxiliary liquid crystal panel on its upper surface, and to display setting modes, photographic conditions, various types of warning and the like upon this auxiliary liquid crystal panel as patterns (by segment display). However, with the camera of this embodiment of the present invention, no such auxiliary liquid crystal panel is provided; rather, by displaying the information that in the prior art was displayed upon the auxiliary liquid crystal panel, instead upon the main liquid crystal monitor 1 that is located upon the camera rear surface, it is anticipated that it will be possible to make the camera more compact, and to reduce its cost.

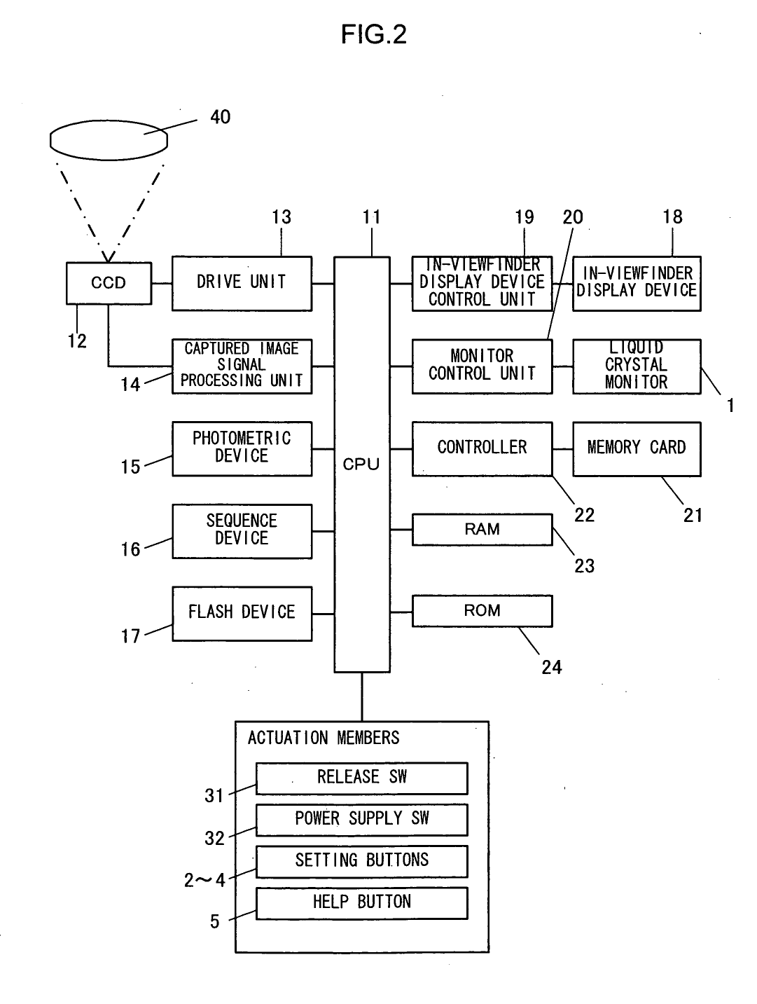

FIG. 2 is a block diagram of a control system of the camera according to this embodiment of the present invention.

The single lens reflex type digital camera (hereinafter simply termed the “camera”) 100 of the present invention includes a CPU 11 and various functional units. To this CPU 11 there are connected a drive unit 13 that drives an image sensor 12 such as a CCD or the like, a captured image signal processing unit 14 that performs various types of processing upon the output of the image sensor 12, a photometric device 15 that detects the luminance of the photographic subject, a sequence device 16 for performing photographic operation, a flash device 17, a control unit (an in-viewfinder display device control unit) 19 that controls an in-viewfinder display device 18, a control unit (a monitor control unit) 20 that controls a liquid crystal monitor 1, a controller 22 that controls recording and reading out of image data to and from a memory card 21, a RAM 23, a ROM 24 that stores programs and so on. Furthermore, as actuation members, there are also connected to this CPU 11 a release switch 31, a power supply switch 32, the various setting buttons 2 to 4, the help button 5, and the like.

When this camera 100 is in the photographic mode, a beam that is transmitted through a photographic lens 40, which is detachably attached to the camera 100, is photoelectrically converted by the image sensor 12, and the captured image signal is subjected to signal processing by the captured image signal processing unit 14, whereby image data is generated. This image data that has been obtained is recorded upon the memory card 21 via the controller 22. Moreover, when this camera 100 is in the replay mode, the CPU 11 is able to read out any desired image data recorded upon the memory card 21 via the controller 22, and to display a replay image based upon this read out image data upon the liquid crystal monitor 1.

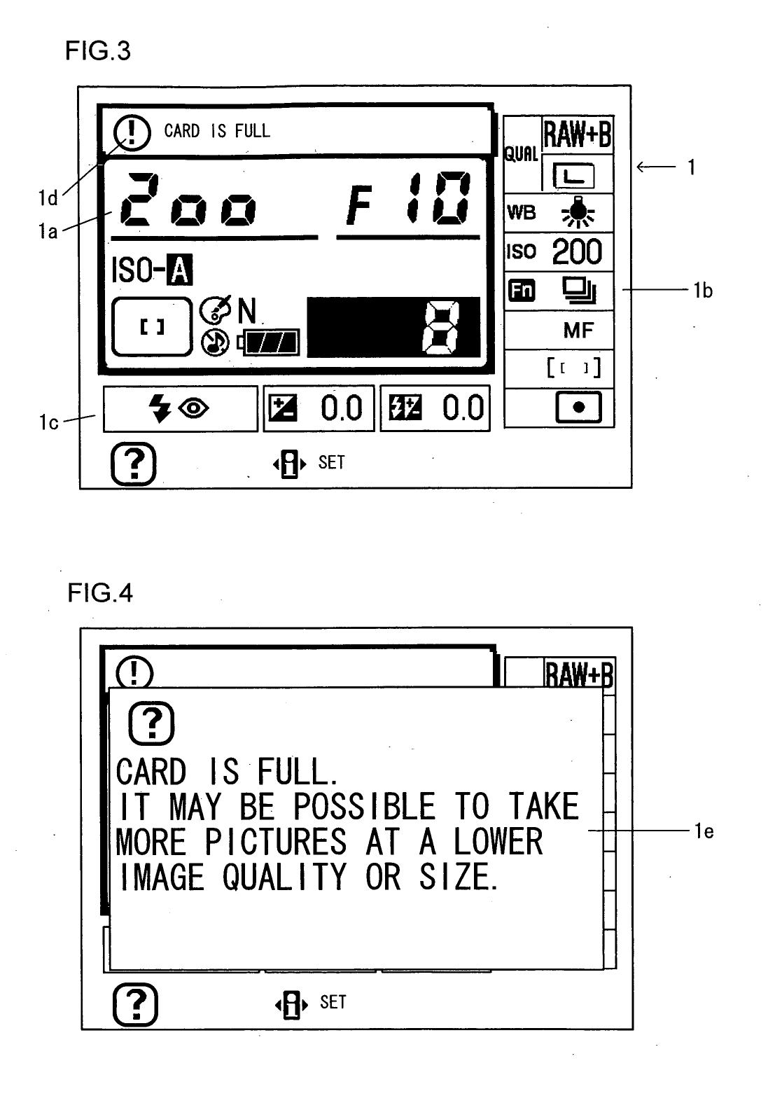

FIG. 3 shows an example of a display during the photographic mode. During this photographic mode, photographic condition display fields 1a to 1c are generated upon the screen of the liquid crystal monitor 1, and various photographic conditions (shutter timing, aperture value, ISO sensitivity, photometric mode, and others) are displayed in these fields. The field 1d is a simple message display field, and will be described in further detail hereinafter.

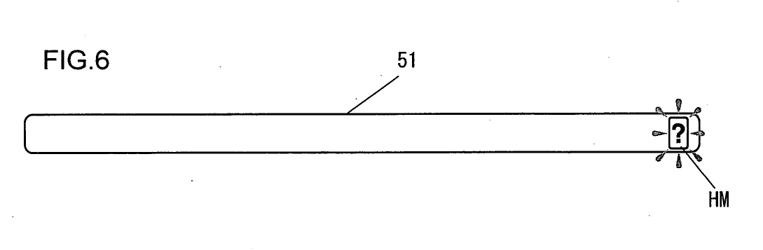

As shown in FIG. 5, the in-viewfinder display device 18 displays information such as photometric mode, battery capacity, various mode settings, photographic conditions and so on upon an in-viewfinder information display unit 51. The mark at the rightmost side of the information display unit 51 is a help mark HM, and this mark is displayed as blinking when some problem has occurred with the camera (refer to FIG. 6). Thus due to the blinking of this help mark HM the photographer, who is looking through the viewfinder, can immediately ascertain that a problem is occurring, and, when he or she presses the help button 5 in order to find out the details of the problem, the details of the problem that is occurring are displayed upon the liquid crystal monitor 1 as a warning message.

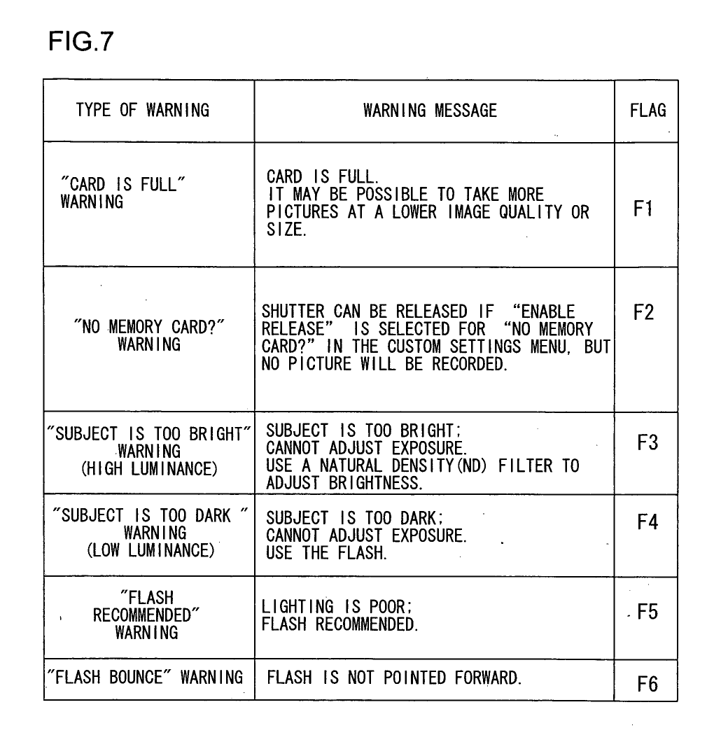

A concrete example of a number of such warning messages is shown in FIG. 7.

Among the six types of warning shown by way of example in FIG. 7, the “card is full” warning and the “no memory card?” warning are warnings that notify the photographer that image recording is impossible, and this exerts an influence upon the photographic operation itself. In more detail, the “card is full” warning notifies the photographer that, although the remaining space on the memory card is insufficient for recording with the combination of picture quality mode and image size that is currently set, there is a possibility that it may be possible to take more pictures at a lower image picture quality or size.

Furthermore, the “no memory card?” warning notifies the photographer that if he or she wants to perform shutter release with no memory card 21 inserted in a memory card reader (not shown) provided in the camera 100, then he or she should select “enable release” in the custom settings, and it also notifies him or her that even if this selection is made the resulting image will not be stored. Note that if “enable release” is not selected, then the shutter release is locked if no card is present in the memory card reader (not shown).

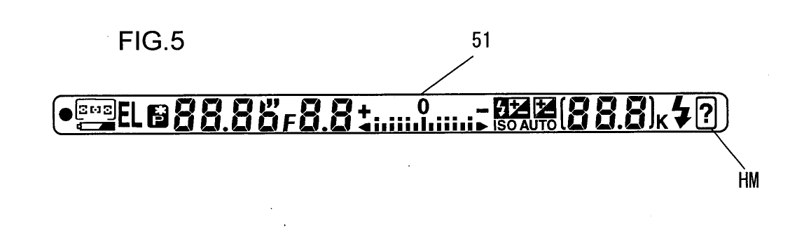

In relation to the two warnings described above, simple warning messages are provided. Each of these simple warning messages is displayed in the simple message display field 1d of the liquid crystal monitor 1 (see FIG. 3) at the time point that the problem is confirmed, in other words at the same time that the help mark HM described above is displayed. When in this state the help button 5 is pressed, the display field 1e is generated with a detailed message as shown in FIG. 4, and this detailed warning message is displayed therein. Since it is necessary to display this detailed warning message large scale in order for it to be easy to read, the detailed message display field 1e is displayed so as to occupy almost the entire screen, i.e. so as to hide the photographic condition display fields 1a to 1c.

Note that although FIG. 3 shows only the simple warning message “card is full”, it would be acceptable to display “memory card not inserted” or the like in the case of the “no memory card?” warning.

According to the above, when the power supply to the camera is turned ON in the state in which no memory card 21 is inserted, or in the state in which a card with insufficient remaining space on it is inserted in the memory card reader (not shown), then, since a simple warning message is immediately displayed upon the liquid crystal monitor 1, accordingly the photographer is enabled to know before he or she looks through the viewfinder that it will not be possible to record any image that he or she may take. By pressing the help button 5 in this state, the photographer is able to be made aware of a method of coping with the problem for which the warning has been issued.

Since the warnings other than the ones described above, i.e. the warnings related to photometry and to flash, are ones that do not exert any influence upon the photographic operation but rather only affect the results of photography, accordingly only simple warning messages are provided in these cases. Accordingly, by displaying a detailed warning message by actuation of the help button 5, it is possible to confirm the contents of the initial message, and to be advised of a method for taking action.

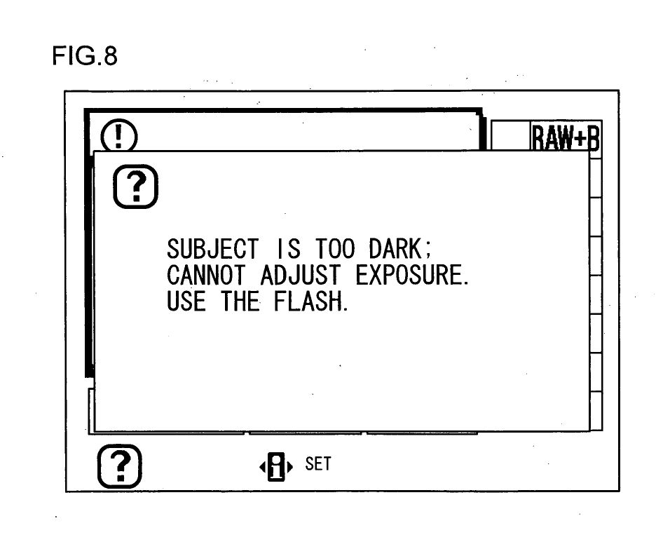

FIG. 8 shows an example in which the “subject is too dark” warning for indicating “outside photometric range” (for low luminance) is displayed. This warning is output when the photometric value is below a low luminance side limit of the range for which photometry is possible, and adequate exposure is impossible unless the flash is used. On the other hand, the “flash recommended” warning is output when lighting is poor, that is, although the photometric value is within the range for which photometry is possible, the shutter timing if the flash is not used becomes long, so that camera shake can easily occur.

Furthermore, the “flash bounce” warning is output when, with the camera in its state in which an externally attached flash unit that is capable of emitting bounce light is mounted, it has been detected by a sensor (not shown) that the light emitting portion of this flash unit is not pointed forward. Although in principle bounce light emission may be performed intentionally with the light emitting portion of such a flash unit is not pointed forwards, this warning message is nevertheless output, in order to avoid such bounce light emission being performed unintentionally.

Thus, in this embodiment, each of the warning messages is not merely displayed as a pattern or icon, but is also displayed as a text document using language characters. Moreover, for almost all of the warning messages, not only are the details of the problem explained, but a method for dealing with the problem is also included. Accordingly, the photographer is able to ascertain the nature of the problem immediately, and also is able to take appropriate measures for dealing with the problem rapidly, without becoming confused.

Furthermore, even if the help mark HM is blinking, no warning message (a detailed message) is displayed unless the help button 5 is actuated. In other words, if the photographer knows the details of the warning message anyway even without seeing the warning, such as for example when bounce light is emitted, then he or she is still able to select non-display of the warning message. According to this, the inconvenience of display of the photographic conditions being hidden by an unnecessary warning message is avoided.

Note that the types of warning and the details of the warning messages should not be considered as being limited to those shown in FIG. 7. Furthermore, it would also be acceptable to arrange for a normal help display (explaining the various functions and so on) to be displayed upon the liquid crystal monitor 1 if the help button 5 is pressed when the help mark HM is not illuminated.

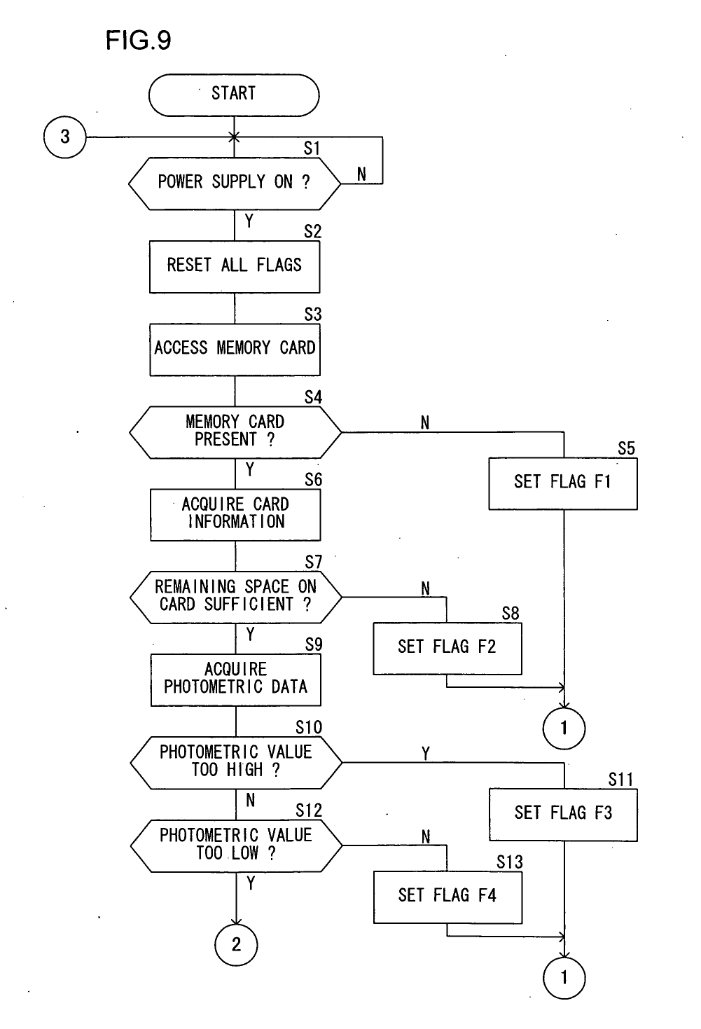

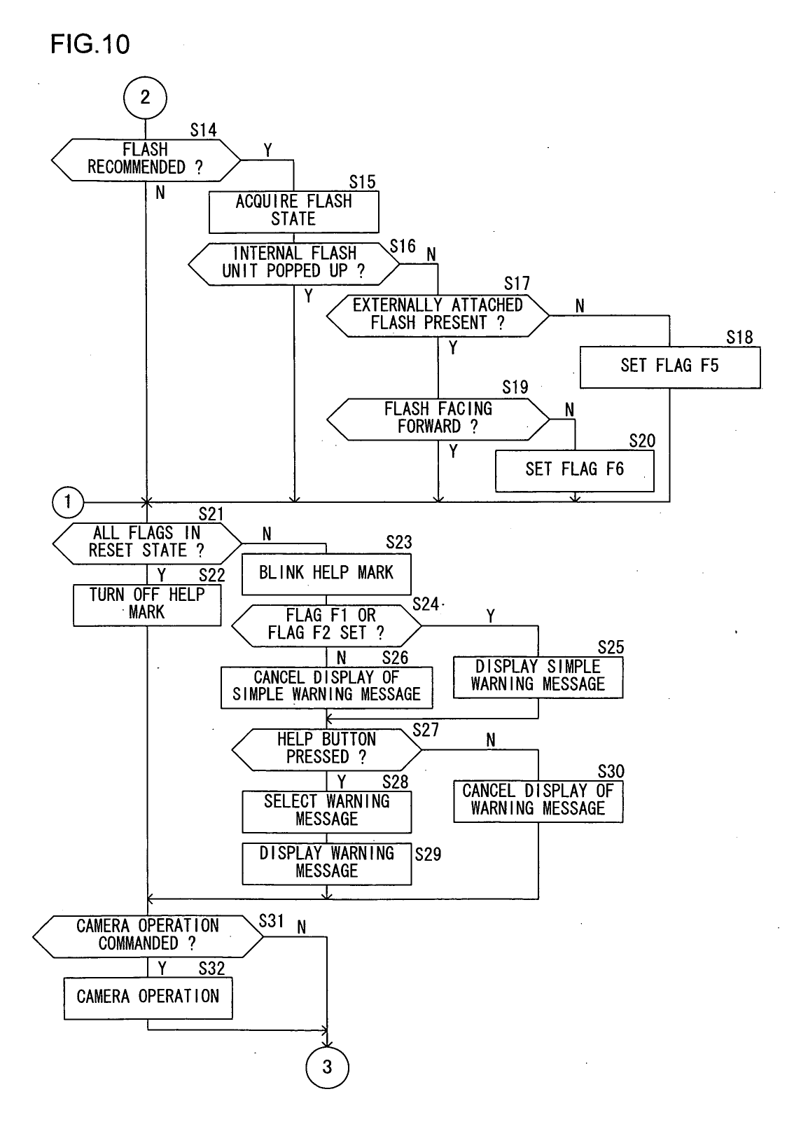

An example of a control sequence that may be performed for implementing the warning displays described above will now be described with reference to the flowcharts of FIGS. 9 and 10.

In cooperation with the other structural portions of this camera 100, the CPU 11 performs various types of processing and control using a program that is stored in the ROM 24. By performing appropriate processing and control according to the operational state of the camera 100, this CPU 11 implements the various functions and operations of the camera 100.

When in a step S1 the CPU 11 has checked that the power supply switch 32 is ON, next in a step S2 it resets flags F1 to F6. These flags correspond to the various warning messages shown in FIG. 7. Next in a step S3 the CPU 11 accesses the memory card 21, and then in a step S4 it decides whether or not the memory card 21 is loaded. If the memory card 21 is loaded, then an affirmative decision is reached in this step S4 and the flow of control is transferred to a step S6, while if the card 21 is not loaded then a negative decision is reached in this step S4 and the flow of control proceeds to a step S5. In this step S5 the flag F1 is set, and then the flow of control is transferred to a step S21.

In the step S6, the CPU 11 acquires information related to the memory card 21, and then in a step S7 it decides whether or not the space available upon the memory card 21 is sufficient. If the space available upon the memory card 21 is sufficient, then an affirmative decision is reached in this step S7 and the flow of control is transferred to a step S9, while if the space available upon the memory card 21 is not sufficient, in other words if the size of the image data for the current picture quality and image size is larger than the remaining space on the memory card 21, then a negative decision is reached in this step S7 and the flow of control proceeds to a step S8. In this step S8 the CPU 11 sets the flag F2, and then the flow of control is transferred to the step S21.

In the step S9, the CPU 11 acquires the photometric value, that is the output of the photometric device 15, and then in a step S10 the CPU 11 decides whether or not this photometric value is too high. This is a decision as to whether or not the luminance of the photographic subject is higher than the high luminance side limit of the range that the exposure control can handle; if a negative decision is reached in this step S10 then the flow of control is transferred to a step S12, while if an affirmative decision is reached then the flow of control proceeds to a step S11. In this step S11 the CPU 11 sets the flag F3, and then the flow of control is transferred to the step S21.

In the step S12, the CPU 11 decides whether or not this photometric value is too low. This is a decision as to whether or not the luminance of the photographic subject is lower than the low luminance side limit of the range that the exposure control can handle; if a negative decision is reached in this step S12 then the flow of control is transferred to a step S14, while if an affirmative decision is reached then the flow of control proceeds to a step S13. In this step S13 the CPU 11 sets the flag F4, and then the flow of control is transferred to the step S21.

In the step S14, the CPU 11 decides whether or not flash photography is appropriate. This is a decision as to whether or not the shutter timing that is calculated based upon the photometric value and the sensitivity gain and soon is longer than a predetermined timing (for example the limit value in consideration of camera shake); if a negative decision is reached in this step S14 then the flow of control is transferred to the step S21, while if an affirmative decision is reached then the flow of control proceeds to a step S15.

In the step S15 the CPU 11 acquires the flash state, and in the next step S16 it makes a decision as to whether or not the flash unit internal to the camera is popped up. If the internal flash unit is popped up then an affirmative decision is reached in this step S16 and the flow of control is transferred to the step S21, while if the internal flash unit is not popped up then a negative decision is reached in this step S16 and the flow of control proceeds to a step S17. In this step S17, the CPU 11 makes a decision as to whether or not an externally attached flash unit is in a state in which it can be used. If a negative decision is reached in this step S17, in other words if neither the internal flash unit nor the externally attached flash unit is in a usable state, then the flow of control proceeds to a step S18. In this step S18 the CPU 11 sets the flag F5, and then the flow of control is transferred to the step S21. But if an affirmative decision is reached in the step S17, in other words if at least one of the internal flash unit and the externally attached flash unit is in a usable state, then the flow of control is transferred to a step S19. In this step S19 the CPU 11 makes a decision as to whether or not the light emission portion of the externally attached flash unit is facing to the front. If the light emission portion of the externally attached flash unit is facing to the front, then an affirmative decision is reached in this step S19 and the flow of control is transferred to the step S21, while if the light emission portion of the externally attached flash unit is not facing to the front, then a negative decision is reached in this step S19, and the flow of control proceeds to a step S20. In this step S20, the CPU 11 sets the flag F6, and then the flow of control proceeds to the step S21.

In the step S21, the CPU checks the states of all of the flags, and if all of the flags are in the reset state then an affirmative decision is reached in this step S21 and the flow of control proceeds to a step S22. In this step S22, the CPU 11 turns off the in-viewfinder help mark HM, and then the flow of control is transferred to a step S31. On the other hand, if in the step S21 any one of the flags is found to be set, then a negative decision is reached in this step S21 and the flow of control is transferred to a step S23. In this step S23, the CPU 11 starts to blink the in-viewfinder help mark HM.

Next, in a step S24, the CPU 11 decides whether either the flag F1 or the flag F2 is set. If either of the flag F1 or the flag F2 is set, then an affirmative decision is reached in this step S24 and the flow of control proceeds to a step S25, and in this step S25 the CPU 11 generates the simple message display field 1d upon the liquid crystal monitor 1, and displays the simple warning message that corresponds to the flag F1 or the flag F2 in this field 1d. On the other hand, if both of the flags F1 and F2 are reset, then a negative decision is reached in this step S24 and the flow of control is transferred to a step S26, and in this step S26 the CPU 11 cancels the display of any simple warning message. In either case, the flow of control is next transferred to the step S27.

In this step S27, the CPU 11 decides whether or not the help button 5 is being pressed; if the help button 5 is being pressed, then an affirmative decision is reached in this step S27 and the flow of control proceeds to a step S28. And, in this step S28, the CPU 11 selects the warning message (the detailed message) that should be displayed. For example, if a table in which the warning messages shown in FIG. 7 are held corresponding to the flags F1 to F6 is stored in the ROM 24, then the warning message that corresponds to the flag that is currently set is selected. Note that only a single warning message can be selected, since two or more of the flags are never set at the same time. When this selection has been performed, the flow of control proceeds to a step S29.

In this step S29, the CPU 11 generates the detailed message display field 1e upon the liquid crystal monitor 1, and displays the warning message that has been selected in this field 1e. Then the control flow is transferred to the step S31. On the other hand, if in the step S27 it is decided that the help button 5 is not being pressed, then a negative decision is reached in this step S27 and the flow of control is transferred to a step S30. In this step S30, the CPU 11 cancels the display of any warning message, and then the flow of control proceeds to the step S31.

Note that although, in this control flow, it is arranged for a warning message to be displayed when the help button 5 is pressed, and for this warning message display to be canceled when the help button 5 ceases to be pressed, it would also be acceptable to arrange, for example, for a warning message to be displayed when the help button 5 is pressed, and for this warning message display to be canceled when the help button 5 is pressed for a second time, i.e. for the help button 5 to operate on a toggle basis.

In the step S31, a check is made as to whether or not a command for camera operation is being issued (for example, whether or not the release switch is ON), and if a command for camera operation is being issued then an affirmative decision is made in this step S31 and the flow of control proceeds to a step S32. In this step S32, the CPU 11 performs the required operation (for example, photography). Then the flow of control loops back to the step S1. On the other hand, if in the step S31 no command for camera operation is being issued, then the flow of control loops back to the step S1 without any further action.

Note that although, in the above explanation, it was arranged to notify the photographer of the occurrence of a problem by blinking the help mark HM, it would also be acceptable to arrange to notify him or her by illuminating or blinking a light emitting element such as a LED or the like. Moreover, this notification is not limited to being of an in-viewfinder type. Yet further, the shape and the position of the help button are not limited by those in the shown embodiment. Furthermore, it would also be possible to provide an audio data storage device and an audio output device (a speaker), and to provide notification via audio. Even further, it would also be acceptable to arrange to provide notification both visually and via audio, i.e. in parallel.

The embodiment described above has only been described as an example; the details of the present invention are not limited thereto, but may be varied as appropriate in any particular case, provided that the scope of the invention is adhered to.

What is claimed is:

1. A camera, comprising:
a first display device;
a detection unit that detects a problem related to photography of which a photographer should be warned; and
a control unit that causes the first display device to display a simple warning message in text indicating that image recording is impossible when a first problem of image recording being impossible is detected by the detection unit, and that controls the first display device to display a detailed warning message that describes in text details of the first problem when a specified actuation is performed by the photographer while the simple warning message is being displayed on the first display device, with a content of the detailed warning message being in more detail than a content of the simple warning message.

2. A camera according to claim 9, wherein the first display device is provided on a rear surface of the camera.

3. A camera according to claim 2, wherein the camera is a single lens reflex digital camera to which a detachable photographic lens is attached.

4. A camera according to claim 1, further comprising:
a second display device other than the first display device within a viewfinder of the camera, wherein
when a second problem inclusive of the first problem of image recording being impossible is detected by the detection unit, the control unit controls the second display device to display a mark indicating the occurrence of the second problem.

5. A camera according to claim 4, wherein
when a third problem that exerts an influence on a result of photography is detected by the detection unit, the control unit controls the second display device to display the mark and the control unit controls the first display device not to display the simple warning message indicating that the third problem that exerts an influence upon the result of photography occurred.

6. A camera according to claim 5, wherein
when the specified actuation is performed by the photographer, the control unit controls the first display device to display the detailed warning message.

7. A camera according to claim 6, wherein
when the specified actuation is performed by the photographer in a case where no problem is detected by the detection unit, a help screen is displayed on the first display device.

8. A camera according to claim 7, wherein
the control unit controls the first display device to display thereon a photographic condition that includes at least one of shutter timing, aperture value, and ISO sensitivity.

9. A camera according to claim 8, wherein
when the specified actuation is performed by the photographer, the control unit controls the first display device to display thereon the detailed warning message so as to hide the photographic condition.
